(19) United States
(12) Patent Application Publication
(10) Pub. No.: US 2026/0289550 A1
(43) Pub. Date: Sep. 24, 2026

(54) IN-PERSON TRANSACTIONS AT POINT-OF-SALE TERMINALS USING SHARED DIGITAL WALLETS

(71) Applicant: Early Warning Services, LLC, Scottdale, AZ (US)

(72) Inventors: Riyad Kalla, Scottdale, AZ (US); John Mwangi, West Orange, NJ (US); Rajesh Kulkarni, Scottsdale, AZ (US)

(73) Assignee: Early Warning Services, LLC, Scottdale, AZ (US)

(21) Appl. No.: 19/571,227

(22) Filed: Mar. 18, 2026

Related U.S. Application Data
(60) Provisional application No. 63/773,629, filed on Mar. 18, 2025.

(51) Int. Cl. G06Q 20/36; G06Q 20/34

(52) U.S. Cl. CPC G06Q 20/36; G06Q 20/34

(57) ABSTRACT

A computer-implemented method including receiving, from a user device, a provisioning request for a payment card. The method also can include retrieving token information associated with the payment card from a wallet directory that stores a shared digital wallet for a user. The shared digital wallet can include payment cards from a plurality of different issuers. The method additionally can include transmitting the token information to a card network to initiate provisioning of the payment card. The method further can include receiving, from the card network, a notification indicating that a payment token for the payment card has been installed on a secure component of the user device. The method also can include storing, in the wallet directory, an indication that the payment card has been provisioned to the user device for use in near field communication transactions at a point-of-sale terminal. Other embodiments are described.

### CROSS-REFERENCE TO RELATED APPLICATION

This application claims the benefit of U.S. Provisional Application No. 63/773,629, filed Mar. 18, 2025, which is incorporated herein by reference in its entirety.

### TECHNICAL FIELD

This disclosure relates generally to in-person transactions at point-of-sale terminals using shared digital wallets.

### BACKGROUND

Digital payment systems have become increasingly prevalent in modern commerce, allowing users to make purchases and transfer funds electronically using various devices and platforms. Near field communication (NFC) technology enables short-range wireless communication between compatible devices, facilitating contactless transactions when devices are positioned in close proximity to each other. Digital wallets provide a mechanism for storing payment instrument information, such as credit card details and bank account information, on electronic devices.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for in-person (e.g., near field communication) transactions at point-of-sale terminals using shared digital wallets, according to an embodiment;

FIG. 4 illustrates a flow diagram of a method of provisioning a card within user device, according to an embodiment;

FIG. 5 illustrates a flow diagram of a method of user device performing an in-person (e.g., NFC) transaction using the payment card as it has been provisioned within user device, according to an embodiment;

FIG. 6 illustrates a flow diagram of a method of processing a user-initiated lifecycle event, according to an embodiment;

FIG. 7 illustrates a flow diagram of a method of processing an issuer-initiated lifecycle event, according to an embodiment; and

FIG. 8 illustrates a flowchart for performing in-person transactions at point-of-sale terminals using shared digital wallets, according to an embodiment.

For simplicity and clarity of illustration, the drawing figures herein illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant. “Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, two minutes, or five minutes.

### DESCRIPTION OF EXAMPLES OF EMBODIMENTS

Various embodiments include a computer-implemented method. The method can include receiving, from a user device, a provisioning request for a payment card. The method also can include retrieving token information associated with the payment card from a wallet directory that stores a shared digital wallet for a user. The shared digital wallet can include payment cards from a plurality of different issuers. The method additionally can include transmitting the token information to a card network to initiate provisioning of the payment card. The method further can include receiving, from the card network, a notification indicating that a payment token for the payment card has been installed on a secure component of the user device. The method also can include storing, in the wallet directory, an indication that the payment card has been provisioned to the user device for use in near field communication transactions at a point-of-sale terminal.

A number of embodiments include a system including one or more processors and one or more non-transitory computer-readable media storing computing instructions that, when executed on the one or more processors, cause the one or more processors to perform operations. The operations can include receiving, from a user device, a provisioning request for a payment card. The operations also can include retrieving token information associated with the payment card from a wallet directory that stores a shared digital wallet for a user. The shared digital wallet can include payment cards from a plurality of different issuers. The operations additionally can include transmitting the token information to a card network to initiate provisioning of the payment card. The operations further can include receiving, from the card network, a notification indicating that a payment token for the payment card has been installed on a secure component of the user device. The operations also can include storing, in the wallet directory, an indication that the payment card has been provisioned to the user device for use in near field communication transactions at a point-of-sale terminal.

For simplicity and clarity of illustration, the drawing figures herein illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant. “Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, or thirty seconds.

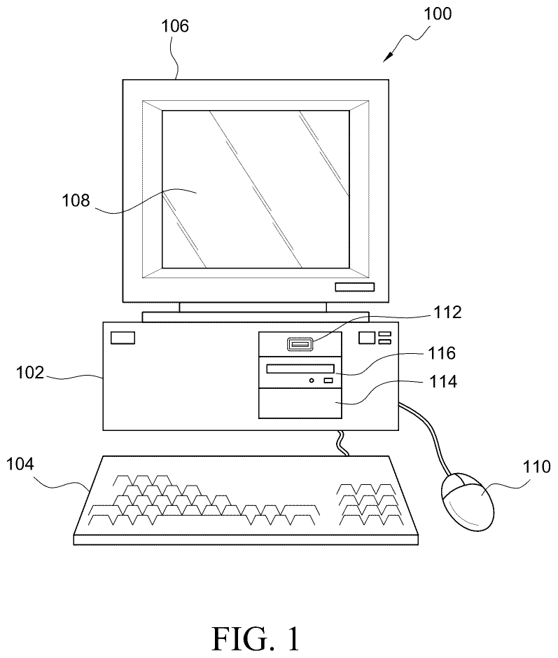

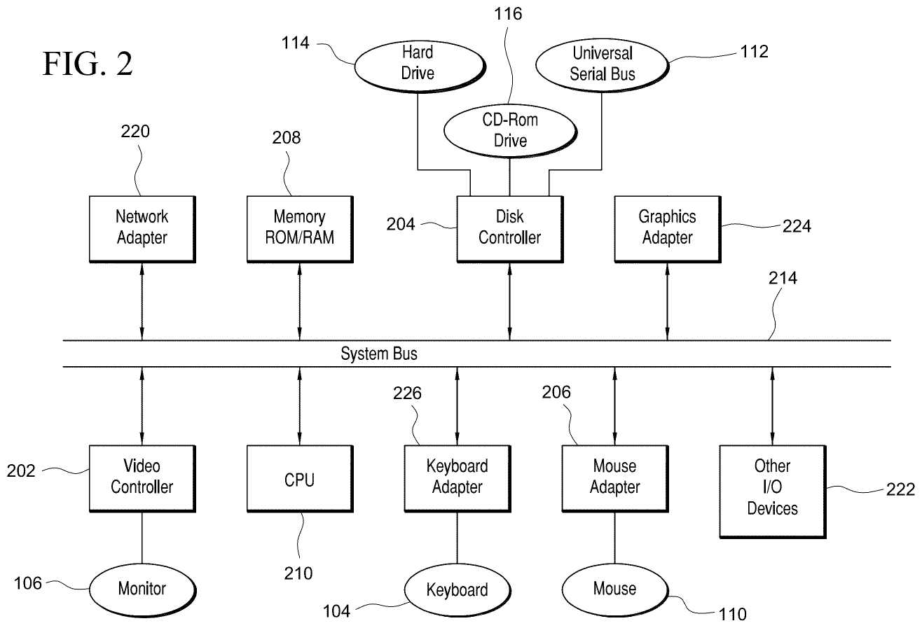

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random-access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIGS. 1-2). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) or Field Programmable Gate Arrays (FPGAs) can be programmed to carry out one or more of the systems and procedures described herein. For example, one or more of the programs and/or executable program components described herein can be implemented in one or more ASICs or FPGAs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

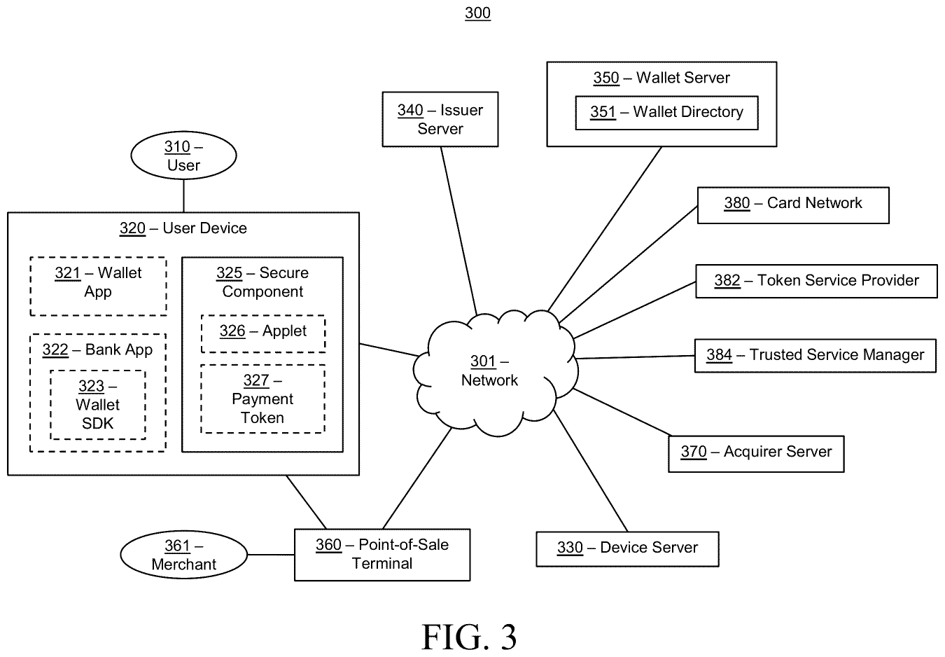

Turning ahead in the drawings, FIG. 3 illustrates a block diagram of a system 300 that can be employed for in-person (e.g., near field communication (NFC)) transactions at point-of-sale terminals using shared digital wallets, according to an embodiment. System 300 is merely exemplary, and embodiments of the system are not limited to the embodiments presented herein. The system can be employed in many different embodiments or examples not specifically depicted or described herein. In some embodiments, certain elements of system 300 can perform various procedures, processes, and/or activities. In other embodiments, the procedures, processes, and/or activities can be performed by other suitable elements of system 300. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include various components, such as one or more user devices (e.g., a user device 320) of one or more user (e.g., a user 310), one or more device servers (e.g., a device server 330), one or more issuer servers (e.g., an issuer server 340), a wallet server 350, one or more point-of-sale terminals (e.g., a point-of-sale terminal 360) of one or more merchants (e.g., merchant 361), one or more acquirer servers (e.g., an acquirer server 370), one or more card networks (e.g., a card network 380), one or more token service providers (TSPs) (e.g., a token service provider 382), one or more trusted service managers (TSMs) (e.g., a trusted service manager 384), and/or other suitable components. In some embodiments, the components of system 300 can be in data communication with each other through a network 301. Network 301 can be the Internet or another suitable network, or multiple different networks. In some embodiments, network 301 can be public or private, or can include one or more public networks and one or more private networks.

The components of system 300, such as user device 320, device server 330, issuer server 340, wallet server 350, point-of-sale terminal 360, acquirer server 370, card network 380, token service provider 382, and/or trusted service manager 384 can each be a computer system, such as computer system 100 (FIG. 1), as described above, and can each be a single computer, a single server, or a cluster or collection of computers or servers, or a cloud of computers or servers. In another embodiment, a single computer system can host multiple components of system 300.

In many embodiments, user device 320 can be a mobile device and/or other endpoint device used by user 310 at a point-of-sale terminal (e.g., 360) of a merchant (e.g., 361). In many embodiments, user device 320 can run a wallet app 321 (e.g., mobile application) that can interface with wallet server 350. In the same or other embodiments, user device can run one or more banking apps (e.g., banking app 322) that includes a wallet SDK (software development kit) 323 that interfaces with wallet server 350. In many embodiments, wallet app 321 and/or banking app 322 can provide a user experience (UX) for provisioning payment cards in a digital wallet, management of the digital wallet, and/or management of provisioned payment cards accessed or used in point-of-sale transactions. In many embodiments, wallet SDK 323 can be provided to a financial institution developing a banking app (e.g., 322) to be embedded within banking app 322, to provide some or all of the functionality that would otherwise be provided by wallet app 321. In many embodiments, wallet app 321 and/or wallet SDK 323 can collect device information for user device 320, determine device capabilities, and/or communicate with token service provider 382, trusted service manager 384, and/or a secure component 325 of user device 320.

In many embodiments, wallet app 321 and/or wallet SDK 323 can collect data and information to help determine device identification and/or verification of the user device 320. For example, the wallet app 321 and/or wallet SDK 323 can communicate with user device 320 to determine and collect a unique identifier for user device 320 and utilize the unique identifier to verify and/or authenticate the user device 320. In some embodiments, wallet app 321 and/or wallet SDK 323 can assist with or otherwise handle user authentication of user device 320 by performing authentication methods such as verifying user credentials, processing biometric data, generating and managing passkeys, and/or generating and validating one-time passwords. In many embodiments, user authentication can occur during or after device verification, such that once verification of user device 320 is complete, verification of the user of that device can be performed. In some embodiments, verification of the user device 320 can be used with other verification methods (e.g., user credential verification, biometric data, passkeys, one-time passwords) to verify the user. In other embodiments, user authentication can occur during a point-of-sale transaction or other activity involving the user 310, the wallet app 321 and/or wallet SDK 323.

In some embodiments wallet app 321 and/or wallet SDK 323 can facilitate communication between or serve as an interface for banking app 322 and token service provider 382. In other embodiments, wallet app 321 and/or wallet SDK 323 can serve as an interface for provisioning data of user device 320 and token service provider 382. For example, wallet app 321 and/or wallet SDK can communicate with token service providers 382 to help with or facilitate providing payment tokens (e.g., 327) to secure component 325 and handling other token events that may occur when provisioning a payment card. In many embodiments, wallet app 321 and/or wallet SDK 323 can communicate with banking app 322 to display payment card information, such as account number, payment card name, and/or payment card image to the user 310. As such, wallet app 321 and/or wallet SDK 323 can help collect and communicate payment card information of payment cards included in a digital wallet, and banking app 322 can display that payment card information to the user 310.

In some embodiments, wallet app 321 can be provided as a standalone app separate from banking apps (e.g., 322) when banking apps do not include a wallet SDK (e.g., 323) for communicating with wallet server 350. In some embodiments, wallet app 321 can be a separate standalone app that is integrated with, communicates with, and/or redirected to by one or more banking apps (e.g., 322). In other embodiments, wallet app 321 can have little to no communication with a banking app (e.g., 322), if any, installed on user device 320. In other embodiments, the user device 320 can separately access and/or interact with wallet app 321 and banking app 322.

In many embodiments, secure component 325 can provide a secure environment for storing sensitive account information and/or functionality associated with payment cards managed by a digital wallet, such as a secure element in iOS-based devices and some Android-based devices, or secure storage in some Android-based devices, Microsoft-based devices, or other operating system-based devices. In many embodiments, secure component 325 can be implemented as a hardware-based secure element within user device 320. Secure component 325 can provide a tamper-resistant platform capable of securely hosting applications and their confidential and cryptographic data. Secure component 325 can resist various physical and software attacks, providing integrity and confidentiality of the account information or data associated with stored payment card information. Secure component 325 can include specialized security hardware, such as a dedicated microprocessor, memory, and cryptographic co-processors. This hardware can be isolated from the main processor and memory of user device 320, providing an additional layer of security. In some implementations, secure component 325 can be a removable smart card chip, while in others it may be embedded directly into the hardware of user device 320.

In many embodiments, the secure component 325 can include one or more applets (e.g., applet 326) and/or one or more payment tokens (e.g., a payment token 327). Within secure component 325, applet 326 can be a small application specifically designed to manage the point-of-sale transaction functionality. Applet 326 can be responsible for tasks such as storing and retrieving payment credentials, generating cryptograms for transactions, managing the lifecycle of payment tokens, and/or communicating with point-of-sale terminal 360. In many embodiments, applet 326 can perform cryptographic calculations in communication with point-of-sale terminal 360 to handle secure point-of-sale transactions. In a number of embodiments, the applets (e.g., 326) can be provided by the card networks (e.g., 380), which can work through trusted service managers (e.g., 384) and device servers (e.g., 330) to provision the applets (e.g., 326) to the user devices (e.g., 320), upon request of the wallet SDK/App (e.g., wallet app 321 or wallet SDK 323) to provision a payment card. If the provisioning request fails to install the applet (e.g., 326) due to an issue with the card or the device, the wallet SDK/App (e.g., wallet app 321 or wallet SDK 323) and/or wallet server 350 can receive failure information (e.g., a geographic restriction on where the card is being provisioned) and can notify the user and/or address the issue.

In many embodiments, payment token 327 stored within the secure component 325 can be a substitute value for a primary account number (PAN) of a payment card (e.g., credit card or debit card) or other sensitive account data. Payment token 327 can be used in place of the actual account number during transactions, adding an extra layer of security by reducing the exposure of the real account information of user 310. For example, payment token 327 can be a payment cryptogram that is precalculated and stored within secure component 325.

In many embodiments, secure component 325 can implement various cryptographic functions to protect the data it stores and processes. These functions can include encryption, digital signatures, and secure key management. Secure component 325 can generate and store cryptographic keys that remain within its protected environment. In certain implementations, secure component 325 can interface with biometric sensors on user device 320, such as fingerprint readers or facial recognition systems, to provide an additional layer of authentication before allowing access to sensitive payment card functions or data. The integration of secure component 325 within user device 320 can enable secure mobile technologies such as NFC transactions, in which secure component 325 can interact directly with checkout terminals (e.g., point-of-sale terminal 360) while keeping sensitive data protected.

In other embodiments, the secure component can additionally and/or alternatively include software elements that are stored on the mobile device, stored remotely from the mobile device on the network or both. In some embodiments, the software elements of the secure component can include host card emulation functions that may be programmed into the wallet app and/or wallet SDK. Within the secure component, the host card emulator can be a small application specifically designed to manage the point-of-sale transaction functionality and can include features that are programmed to be responsible for tasks such as storing and retrieving payment credentials, generating cryptograms for transactions, managing the lifecycle of payment tokens, and/or communicating with point-of-sale terminal. In many embodiments, host card emulator of the secure component can perform cryptographic calculations in communication with point-of-sale terminal to handle secure point-of-sale transactions. In a number of embodiments, the host card emulator is programmed into the wallet app and/or wallet SDK and can communicate with the payment card networks, which can work through trusted service managers and device servers to provision the secure element and host card emulator to the user devices. Once the secure element is provisioned to a user device, the secure element and host card emulator can provision a payment card upon request of the wallet SDK/App. If the provisioning request fails to install the host card emulator due to an issue with the card or the device, the wallet SDK/App and/or wallet server can receive failure information (e.g., a geographic restriction on where the card is being provisioned) and can notify the user and/or address the issue.

In some embodiments, the payment token stored on the network and linked to or otherwise in communication with the host card emulator and the secure component of mobile device. In some embodiments, the payment token can be mapped to a payment card and the payment token can be a substitute value for a primary account number (PAN) of the payment card (e.g., credit card or debit card) or other sensitive account data. The payment token can be used in place of the actual account number during transactions, adding an extra layer of security by reducing the exposure of the real account information of user. For example, payment token can be a payment cryptogram that is precalculated and stored on the network and linked to the host card emulator of the secure element.

In certain embodiments, user device 320 can be a mobile device. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., a smartwatch, smart glasses, etc.), or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook®, Apple Watch, Apple Vision Pro or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, or (ii) the Android™ operating system developed by the Open Handset Alliance.

In many embodiments, the components of system 300 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the systems of system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of the system of systems 300. In a similar manner, the processors and/or the non-transitory computer-readable media can be local and/or remote to each other.

Meanwhile, in many embodiments, the components of system 300 also can be configured to communicate with one or more databases. The one or more databases can include a wallet directory 351, for example, among other databases. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units. In some embodiments, the one or more databases can be hosted on cloud-based infrastructure, such as cloud storage services provided by third-party cloud computing platforms. In these or other embodiments, the components of system 300, such as wallet server 350, can access the one or more databases through cloud infrastructure, which can include distributed cloud architectures that store database contents across multiple geographically distributed data centers. In some embodiments, cloud-based database configurations can provide scalability, redundancy, and accessibility benefits, allowing the components of system 300 to retrieve and store data without requiring local storage of the database contents. In certain embodiments, a hybrid approach can be employed, in which some databases or portions thereof are stored locally on memory storage units while other databases or portions thereof are accessed through cloud-based services.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, the components of system 300, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution F(EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, wallet server 350 can provide digital wallet services to provide a shared wallet for multiple payment cards (e.g., credit cards, debit cards, etc.), such as from various different issuers. The payment cards each can be associated with a particular card network (e.g., card network 380). For example, a first payment card can be associated with the first card network, and a second payment card can be associated with the second card network. The first payment card can be provided by a different issuer than the second payment card, and/or the first card network can be different from the second card network.

In various embodiments, wallet server 350 can create and/or store a digital wallet for each user (e.g., 310) in a wallet directory 351. The wallet can be a single shared wallet for a user (e.g., 310) that can be used for multiple different payment cards associated with the user, including multiple cards from different issuers. Wallet directory 351 can be a database that stores wallets for users (e.g., 310). The wallets can include personal information, such as names, addresses, email addresses, phone numbers (e.g., mobile phone number of a user device (e.g., 320)), social security number (or hash thereof), payment data (e.g., tokenized payment credentials, etc.), bank names of enrolled credentials, an indication of the default payment card for a wallet for a user, whether the user has successfully completed a transaction, the state of the wallet, etc. In some embodiments, wallet directory 351 can be distributed across multiple systems of storage devices. In several embodiments, each wallet in wallet directory 351 can include a wallet identifier or other key that can be used to associate the various elements of the respective wallet. In some embodiments, wallet directory 351 can be completely within wallet server 350. In other embodiments, wallet directory 351 can be outside wallet server 350. In yet other embodiments, wallet directory 351 can be a distributed database that is partially within wallet server 350 and partially within another system. In many embodiments, wallet directory 351 can be centralized, so that it handles payment cards across multiple issuers.

In some embodiments, wallet server 350 also can provide an eCommerce wallet, so that online merchants can provide an identifier of a user (e.g., email address, phone number, and/or other identifying information of the user) to allow or enable the user to access the cards in the wallet directory associated with the user in wallet server 350, and to provide wallet services, such as delivering payment credentials to merchants for a selected card in the wallet directory for the user. For example, the wallet services can be the Paze^{SM} service provided by Early Warning Services, LLC, of Scottsdale, Arizona, or another suitable wallet service. In many embodiments, wallet server 350 can orchestrate card provisioning of cards within the wallet directory to user device 320, manage token or applet lifecycle, and/or manage wallet states. In some embodiments, wallet server 350 can provide wallet services to manage multiple payment cards (e.g., credit cards, debit cards, etc.), potentially from various different issuers. Wallet server 350 can provide wallet services to multiple different merchants (e.g., 361), each using a one or more point-of-sale terminals (e.g., 360). In some embodiments, wallet server 350 can be provided and/or operated by an entity that is different from the merchants (e.g., 361) operating point-of-sale terminals (e.g., 360), the issuers operating the issuer servers (e.g., 340), the acquirers operating acquirer servers (e.g., 370), the card networks (e.g., 380), the token service providers (e.g., 382), and/or the trusted service providers (e.g., 384).

In many embodiments, wallet server 350 can serve as a central component in the digital or electronic commerce ecosystem of system 300, providing a range of services to facilitate secure and convenient electronic transactions. Wallet server 350 can act as a bridge between users, merchants, and financial institutions, enabling seamless integration of various purchase methods and enhancing the overall user experience. Wallet server 350 can digitally store the wallet directory for each user in database. The wallet directory for each user can be associated with one or more payment instruments such as credit cards, debit cards, bank accounts, or other payment methods. This centralized storage allows users to access their payment instrument information across multiple devices and platforms, providing a consistent experience regardless of how or which instrument they choose to complete a transaction. In some implementations, wallet server 350 may provide tokenization services, working in conjunction with token service provider 382 to replace sensitive payment card data with secure tokens. These tokens can be used for transactions without exposing the underlying card details, to provide for enhanced security and reducing the risk of fraud. In some embodiments, wallet server 350 can handle user authentication and authorization, which in some cases can implement multi-factor authentication methods to seek to ensure access to wallet information is limited to authorized users. These methods can include verifying user credentials, processing biometric data, generating and managing passkeys, and/or generating and validating one-time passwords.

In many embodiments, wallet server 350 can provide interfaces, such as APIs (Application Programming Interfaces) that provide for communication and/or integration with wallet app 321, banking app 322, wallet SDK 323, and/or secure component 325 of user devices (e.g., 320), device servers (e.g., 330), issuer servers (e.g., 340), acquirer servers (e.g., 370), card networks (e.g. 380), token service providers (e.g., 382), and/or trusted service managers (e.g., 384). For example, wallet server 350 can communicate with user devices (e.g., 320) to receive card provisioning requests. Wallet server 350 can communicate with issuer servers (e.g., 340) for card provisioning and/or notifications. Wallet server 350 can communicate with device servers (e.g., 330) for requesting installation of applets (e.g., 326) and/or providing payment tokens (e.g., 327) to secure component 325. Wallet server 350 can communicate with token service providers (e.g., 382) for handling token events, such as when provisioning a card. Wallet server 350 can communicate with trusted service managers (e.g., 384) for requesting personalization for a device type of user device 320. In many embodiments, wallet server 350 may implement security measures to protect user data and prevent unauthorized access, such as encryption of data in transit and/or at rest.

The device servers (e.g. 330) can manage device-specific provisioning, such as installing applets (e.g., 326) and/or providing payment tokens (e.g., 327) to secure component 325 of user device 320. In many embodiments, device server 330 can be a secure element issuer that installs an applet on the secure element. For example, for user devices (e.g., 320) that use the iOS operating system, device server 330 can be an Apple Server that installs the applets (e.g., 326) onto the secure element (e.g., secure component 325) of user device 320 to facilitate provisioning the cards for NFC point-of-sale transactions. For user devices (e.g., 320) that use the Android operating system, device server 330 can be an Android server (e.g., the Google Pay server or another suitable server) to facilitate provisioning the cards for NFC point-of-sale transactions. Device servers 330 can facilitating secure transactions between user devices and payment networks. In many embodiments, the device server 330 can handle user authentication, which can include verifying user credentials, processing biometric data, generating and managing passkeys, and/or generating and validating one-time passwords, manage device-specific tokens, and coordinate with the token service provider 382 and/or trusted service manager 384 to provide secure tokenization of payment credentials.

In many embodiments, the issuer servers (e.g., 340) can be operated by the financial institutions that issue payment cards to users (e.g., 310). Issuer server 340 can pre-provision cards onto wallet directories within wallet server 350 and/or receive transaction notifications. Issuer server 340 can authorize or decline point-of-sale or other such transactions based on factors such as account balance, credit limit, and fraud detection algorithms. Issuer server 340 can maintain user account information, including transaction history, credit scores, and personal details, which it can use to make informed decisions about transaction approvals. In some implementations, issuer server 340 can interface with card network 380 to receive authorization requests and send back approval or denial responses in real-time. Issuer server 340 can handle the provisioning of payment tokens in coordination with the token service provider 382, enabling secure tokenized transactions. Issuer server 340 can handle settling transactions to provide payments to acquirers for merchants receiving payment for approved transactions and debiting that user accounts accordingly.

In many embodiments, the point-of-sale terminals (e.g., 360) can provide an interface between merchants (e.g., 361) and customers (e.g., user 310) for processing point-of-sale transactions in physical retail environments. In many embodiments, point-of-sale terminal 360 may be equipped with various technologies to accept different payment instruments and/or methods, including magnetic stripe readers, chip card readers, and/or NFC capabilities for contactless payments. In many embodiments, a user 310 can position user device 320 within proximity (e.g., within 4 centimeters) of point-of-sale terminal 360 to enable the NFC transaction. Point-of-sale terminal 360 can securely capture payment instrument information from user device 320 and transmit this data to acquirer server 370 for processing. In some implementations, point-of-sale terminal 360 can include a display screen to show transaction details, a keypad for PIN entry, and a printer for generating receipts.

In many embodiments, the acquirer servers (e.g., 370) can be an intermediary between merchants (e.g., 361) and card networks (e.g., 380) to process point-of-sale transactions on behalf of the merchants. In many embodiments, acquirer server 370 can be operated by an acquirer financial institution that maintains an account of the merchant and/or a payment service provider or payment service processor on behalf of the merchant. In many embodiments, acquirer server 370 can receive transaction data from point-of-sale terminals 360 or online payment gateways, format this data according to card network specifications, and route it to the appropriate card network (e.g., 380) for authorization. Acquirer server 370 also can handle the settlement process to provide that funds for approved transactions are transferred from issuing banks to merchant accounts. In some implementations, acquirer server 370 can provide additional services to merchants, such as fraud detection, chargeback management, and reporting tools to help analyze transaction data.

In many embodiments, card networks (e.g., 380) can provide an infrastructure that facilitates communication and transaction processing between merchants, acquirers, and issuers for card payments. For example, the card networks can be provided by VISA, MasterCard, Discover, American Express, or another suitable card network. In many embodiments, card network 380 can establish and maintain the rules, standards, and protocols for processing credit, debit, and prepaid card transactions to provide for interoperability across different financial institutions and merchants. Card network 380 can route authorization requests from acquirers to issuers, and then relay the responses back, enabling real-time transaction approvals. In many embodiments, token service provider 382 and/or trusted service manager 384 can be hosted by or provided by card network 380.

In many embodiments, the token service provider 382 can facilitate payment security by generating, issuing, and managing payment tokens that are used in place of sensitive card data in transactions. In many embodiments, token service provider 382 can provide PAN tokens for payment cards and/or notify token lifecycle events. Token service provider 382 can maintain a secure token vault that maps tokens to their corresponding primary account numbers (PANs), enabling the detokenization process when necessary for transaction processing. Token service provider 382 can be part of or interface with card networks 380, and/or can interface with issuers to provide integration of tokenization services across payment channels and devices. In many embodiments, token service providers (e.g., 382) like Mastercard Digital Enablement Service (MDES) or Visa Token Service (VTS) can handle transactions by first receiving a payment token from the merchant or acquirer and then performing a secure lookup to retrieve the corresponding real card number. Token service provider 382 can then forward the real card number to the issuer for authorization, while maintaining the token throughout the rest of the payment flow, thereby enhancing security by keeping the actual card details protected during the transaction process.

In many embodiments, the trusted service managers (e.g., 384) can provide personalization services for the particular device type of user device 320 for NFC transactions. For example, trusted service manager 384 can provide personalization services for applets 326 during setup with issuer and/or user details, data preparation, and/or key management for secure communications. Trusted service manager 384 can provide a neutral intermediary that securely manages the provisioning and lifecycle of payment credentials on user device 320. In many embodiments, trusted service manager 384 can facilitate the remote installation, personalization, and management of payment applications and credentials on user device 320. Trusted service manager 384 can implement security protocols and encryption methods to provide for the integrity and confidentiality of sensitive payment data during transmission and storage on user device 320.

In many embodiments, system 300 and/or various components thereof can provide a technical improvement to address of number of technical problems. Digital payment systems have become increasingly prevalent in modern commerce. These systems allow users to make purchases and transfer funds electronically using various devices and platforms. NFC technology has emerged as a popular method for facilitating contactless purchase transactions. NFC enables short-range wireless communication between compatible devices, allowing users to make purchases or transfer funds by simply tapping or holding their device near a point-of-sale or checkout terminal. This technology has been adopted by many smartphone manufacturers to provide convenient payment options to consumers. Digital wallets also have gained traction as a means of storing payment instrument information and facilitating transactions. These virtual wallets can securely store credit card details, bank account information, and other payment credentials on a user's device. When combined with NFC technology, digital wallets enable users to make purchases or transfer funds without the need to carry physical cards or cash. However, conventional approaches present a number of technical problems. For example, existing wallets, such as those provided by smartphone manufacturers, ask users for their payment card information, and the user generally enters in the payment card information by entering it using an on-screen keyboard or by using the smartphone to take a picture of the card. The payment card information can include card number, cardholder name, card expiration date, card verification number (e.g., card verification value (CVV) is a multi-digit code used for verification by the Visa payment network, and a card verification code (CVC) is a multi-digit code used for verification by the Mastercard payment network), ZIP code, etc.

In many embodiments, the systems and methods described herein can enable a user (e.g., 310) to provision a payment card to the user device (e.g., 320) to allow the payment card to be used in NFC transactions without the user entering card information for the card. In many embodiments, the systems and methods can include a wallet SDK/App (e.g., wallet app 321 or wallet SDK 323) on user device 320, interfacing with a wallet server 350 that stores a shared wallet for the user, in order to obtain card information for the user across multiple issuers. For example, the shared digital wallet for the user stored in wallet server 350 can be similar or identical to the shared wallet described in U.S. Patent Application Publication No. 2024/0370852 and U.S. Patent Application No. 2024/0346479, both of which are incorporated herein by reference in their entirety. In many embodiments, the wallet SDK/App (e.g., wallet app 321 or wallet SDK 323) on user device 320, in conjunction with wallet server 350, can provide a unified architecture that enables seamless provisioning and management of tokenized payment credentials across multiple issuing banks and mobile digital wallet providers, reducing integration complexity and enhancing interoperability, to enable NFC transactions on user device 320. In many embodiments, cards from multiple issuers can be provisioned using the wallet SDK/App (e.g., wallet app 321 or wallet SDK 323). For example, if wallet SDK 323 is part of a bank app (e.g., 322) for a first bank that issued a first card to user 310, and a second bank has issued a second card to user 310, wallet SDK 323 of the bank app (e.g., 322) for the first bank can be used to provision the second card to the user device, even though the card was issued by the second bank, which is a different bank than the first bank that provided the bank app (e.g., 322).

Provisioning a card to a user device can refer to the process of securely adding and activating a digital version of a payment card on the user device (e.g., 320). In many embodiments, this process may involve securely transmitting the card details to the user device in the form of a tokenized representation of the card and storing this information in secure component 325, as described below in further detail. Once provisioned, the digital card may be ready for use in mobile transactions, allowing the user to make purchases or complete transactions using their device without using the physical payment card. In many embodiments, NFC transactions from a mobile device can leverage NFC technology to enable contactless transactions between a user device 320 and point-of-sale terminal 360. In many embodiments, when user 310 initiates a purchase, secure component 325 of user device 320 can generate a unique cryptogram using the stored payment token and transaction-specific data. User device 320 can then transmit this cryptogram, along with the payment token, to point-of-sale terminal 360 via NFC when user device 320 is held within proximity to the terminal. Point-of-sale terminal 360 can forward this information to acquirer server 370, which can then route it through the card network for authorization. Issuer server 340 can verify the cryptogram and token, check the account status, and send an approval or denial response back through the same path. Upon receiving approval, point-of-sale terminal 360 can complete the transaction and generate a receipt. This process can occur within in real-time, providing a fast, secure, and convenient purchase experience for users. In the context of user devices (e.g., 320) operating an iOS operating system, low-level personalization communications can follow the ISO 7816 standard for secure communication and interoperability between Apple's Secure Element (e.g., secure component 325), the NFC interface, and point-of-sale or checkout terminals (e.g., point-of-sale terminal 360).

When using a banking app (e.g., 322), the banking app and/or the financial institution providing the banking app can configure and/or manage wallet SDK 323, although SDK was provided by an entity that is different from the financial institution. The wallet SDK/App (e.g., wallet app 321 or wallet SDK 323) can provide functionality capable of presenting the contents of the shared wallet and initiating card provisioning into secure component 325. The wallet SDK/App (e.g., wallet app 321 or wallet SDK 323) can initiate placement of provisioned cards onto secure component 325 and/or enable use of the payment credentials during a commercial transaction. For example, during a commercial transaction, the exchange of payment information can be an NFC transaction, which can be initiated by a “tap to pay” action initiated by detection of user device 320 in proximity to point-of-sale terminal 360 or by initiating the NFC transaction through user device 320, such as by double-clicking the side button of user device 320.

In many embodiments, wallet app 321 can be a standalone app downloaded by a user through a content store (e.g., Apple Store, Google Play Store), and can be executed by user device 320 for use by user 310 to provision cards from the shared wallet of user 310 that are stored in wallet directory 351 of wallet server 350. For example, user 310 can open banking app 322 on user device 320 and can be redirected to wallet app 321, if already installed, or to download wallet app 321 from the content store. Wallet app 321 can communicate with various different bank apps (e.g., 322) so that users can be directed to their individual banking apps (e.g., 322) to provision cards to be added to the wallet or to claim their wallet with cards preloaded for provisioning. Wallet app 321 and/or bank app 322 can provide authentication of user 310 and/or verification of the cards when using wallet app 321.

As an example, wallet app 321 can be used when authentication is performed through bank app 322. For example, user 310 can launch bank app 322 on user device 320 and log in to bank app 322, then select an option within bank app 322 to use wallet app 321. Selecting wallet app 321 can launch and redirect user 310 to wallet app 321, or if not already installed, can open the content store to allow user 310 to install wallet app 321. Within wallet app 321, cards in the shared wallet of user 310 can be displayed. If there are no cards already in the wallet, or if user 310 desires to add additional cards, user 310 can select an option for the financial institution that issued the card within wallet app 321 to launch the bank app (e.g., 322) for that financial institution. Within bank app 322, user 310 can select one or more payment cards to be added to the wallet to enable in-person payments using user device 320. User 310 can repeat the process to add additional payment cards from that bank app or select one or more additional financial institutions to add cards issued from those additional, different financial institutions. After user 310 has added all the cards desired, wallet app 321 can enable or prompt user 310 to select a default card. Wallet app 321 also can instruct user 310 how to setup the wallet in wallet app 321 as the default digital wallet app in user device 320, so that when user 310 activates or initiates a payment, such as by double clicking a side button on user device 320 or moving user device 320 within proximity of point-of-sale terminal 360, the digital wallet provisioned by wallet app 321 can be activated for use and the desired payment card can be used to complete the transaction. Wallet app 321 can also authenticate user 310 during provisioning of the digital wallet and/or during a point-of-sale transaction. Wallet app 321 can utilize authentication methods such as verifying user credentials, processing biometric data, generating and managing passkeys, and/or generating and validating one-time passwords.

As another example, wallet app 321 can be used when authentication is performed through wallet app 321. For example, user 310 can launch bank app 322 on user device 320 and log in to bank app 322, then select an option within bank app 322 to use wallet app 321. Selecting wallet app 321 can launch and redirect user 310 to wallet app 321, or if not already installed, can open the content store to allow user 310 to install wallet app 321. Alternatively, user 310 can launch wallet app 321 directly without first launching bank app 322. In either case, within wallet app 321, user 310 can be authenticated by wallet app 321, such as by asking user 310 to enter contact information of the user (e.g., an email address or phone number of the user), after which a code can be sent to that email address or phone number, and wallet app 321 asks the user to enter the code, to authenticate that the user is associated with that user contact information associated with a digital wallet of user 310. If user 310 has not already setup the wallet, wallet app 321 can ask user 310 to agree to using the shared wallet service, which can result in the pre-populated shared wallet for user 310 being claimed. Wallet app 321 can pull information from wallet server 350 about the eligible cards associated with user 310 in the shared wallet of the user and display these cards to user 310. The cards can be from the same and/or different issuers. Wallet app 321 can perform verification of each card, such as by asking user 310 to enter the card verification number for each card. Once the cards have been verified, wallet app 321 can allow user 310 to add the verified payment cards for in-person transactions using user device 320. After user 310 has added all the payment cards desired, wallet app 321 can allow user 310 to select a default payment card. Wallet app 321 also can instruct user 310 how to setup the wallet in wallet app 321 as the default wallet app in user device 320, so that when user 310 activates or initiates a payment during a transaction, such as by double clicking a side button on user device 320 or moving user device 320 within proximity of point-of-sale terminal 360, the digital wallet provisioned by wallet app 321 can be activated for use and the desired payment card can be used to complete the transaction.

In many embodiments, when using banking app 322 including wallet SDK 323, users (e.g., 310) can use banking app 322 and wallet SDK 323 to provision eligible cards specifically for that financial institution that provided the banking app. In such embodiments, only cards from that financial institution are available to use within the banking app and provisioned to the user's digital wallet. For example, in such cases, banking app 322 provided by a first bank can be used to provision cards issued by the first bank, but not by other banks. Alternatively, wallet SDK 323 can be used in banking apps (e.g., 322) to allow provisioning of any eligible cards from any financial institution, including from different financial institutions than the one that provided the banking app (e.g., 322). For example, in the latter scenario, a user can use a banking app (e.g., 322) provided by a first bank, and can provision cards through wallet SDK 323 of that banking app (e.g., 322) that were issued by the first bank as well as cards issued by other banks that are different from the first bank. In many embodiments, when using the banking app (e.g., 322), the financial institution that issued the banking app can handle authentication of the user.

As an example, SDK 323 within banking app 322 can be used when authentication is performed through bank app 322. For example, user 310 can launch bank app 322 on user device 320 and log in to bank app 322, then select an option within bank app 322 to use the wallet functionality of wallet SDK 323. Selecting wallet SDK 323 can launch functionality similar to that provided by wallet app 321 and described above, but can be provided by SDK 323 operating within bank app 322. For example, if user 310 has not already setup the digital wallet, wallet SDK 323 can ask user 310 to agree to using the shared wallet service, which can result in the pre-populated unclaimed shared digital wallet for user 310 being claimed. Wallet SDK 323 can pull information from wallet server 350 about the eligible payment cards associated with user 310 in the shared wallet of the user and display these cards to user 310. The payment cards can be from the same and/or different issuers. Wallet SDK 323 can allow user 310 to add the payment cards for in-person transactions using user device 320. If the user desires to add additional payment cards, user 310 can select an option within wallet SDK 323 for the financial institution (issuer) that issued the card to be added to allow the user to log in to that financial institution. Once signed in, the user can add payment cards from that financial institution to the digital wallet. User 310 can repeat the process to add additional cards. After user 310 has added all the payment cards desired, wallet SDK 323 can allow user 310 to select a default payment card. Wallet SDK 323 also can instruct user 310 how to setup the digital wallet in bank app 322 and wallet SDK 323 as the default digital wallet app in user device 320, so that when the user activates or initiates a purchase to complete a transaction, such as by double clicking a side button on user device 320 or moving user device 320 within proximity of point-of-sale terminal 360, the digital wallet provisioned by bank app 322 and wallet SDK 323 can be activated for use and the desired payment card can be used to complete the transaction.

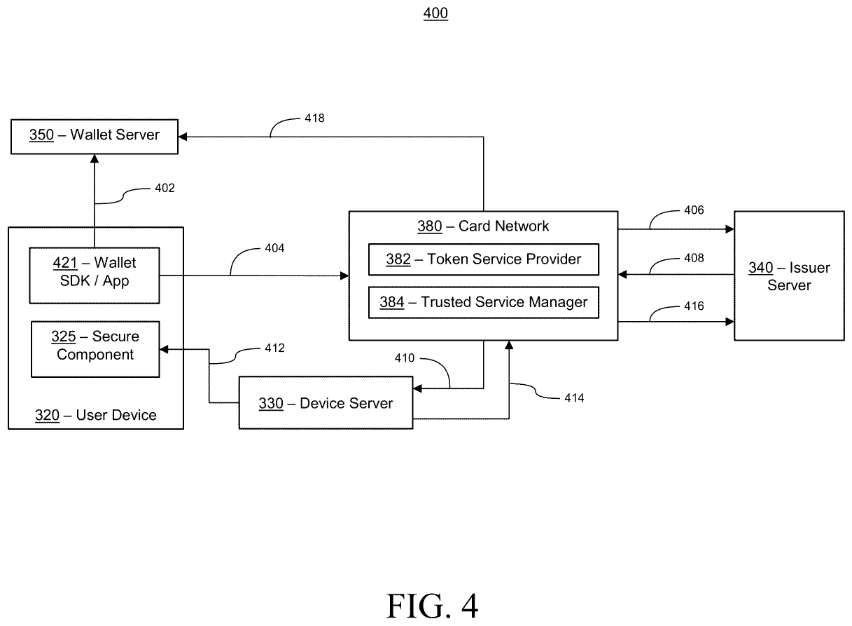

Turning ahead in the drawings, FIG. 4 illustrates a flow diagram of a method 400 of provisioning a card within user device 320, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, method 400 can be involve various interactions between various components of system 300 (FIG. 3). For example, method 400 can involve interactions between a user device 320, wallet server 350, card network 380, issuer server 340, and/or device server 330. User device 320 can include a wallet component 421 (e.g., wallet app 321 (FIG. 3) or wallet SDK 323 (FIG. 3) within banking app 322 (FIG. 3)). In these or other embodiments, one or more of the activities of method 400 can be implemented as one or more computing instructions configured to run at one or more processors and configured to be stored at one or more non-transitory computer readable media. Such non-transitory computer readable media can be part of system 300 (FIG. 3) and/or the components thereof. The processor(s) can be similar or identical to the processor(s) described above with respect to computer system 100 (FIG. 1). In some embodiments, method 400 and other activities in method 400 can include using a distributed network including distributed memory architecture to perform the associated activity. This distributed architecture can reduce the impact on the network and system resources to reduce congestion in bottlenecks while still allowing data to be accessible from a central location. Although communications between multiple components of system 300 (FIG. 3) are described, it is contemplated that method 400 can be performed any single component of system 300 (FIG. 3) or by multiple components of system 300 (FIG. 3). For example, method 400 can involve the activities performed by a single component of system 300 (FIG. 3), such as the activities performed by wallet component 421 of user device 320.

Referring to FIG. 4, method 400 can include an activity 402 of wallet component 421 requesting and receiving token information from wallet server 350. In many embodiments, the token information can be information to be used by card network 380. In some embodiments, the token information from wallet server 350 can include a unique identifier for the card. In many embodiments, the unique identifier can be different from the card number or PAN of the card. In some embodiments, the token information can include a billing address for the user.

In several embodiments, method 400 also can include an activity 404 of sending a provisioning request from wallet component 421 to card network 380. In many embodiments, wallet component 421 can determine and collect device information about user device 320, such as the type of secure component 325 in user device 320 (e.g., a secure element, software storage, etc.), the type of operating system and/or chip set of user device 320, the owner of user device 320 (e.g., whether the owner is the user or someone else), and/or other suitable information. In many embodiments, wallet component 421 can determine risk information, such as a device score representing the fraud risk for user device 320, which can be calculated based on the device information, and/or an account score for the user and/or the wallet of the user. In many embodiments, the provisioning request sent in activity 404 can include the device information, the token information obtained from wallet server 350, the risk information, location data, IP (internal protocol) address, and/or other suitable information.

In a number of embodiments, method 400 additionally can include an activity 406 of card network 380 sending an identity verification request to issuer server 340. In many embodiments, the identity verification request can include the information sent in the provisioning request of activity 404, which can allow the financial institution operating issuer server 340 to make a decision on the identity verification request, such as approve, decline, or require additional authentication.

In several embodiments, method 400 further can include an activity 408 of issuer server 340 sending a response to the identity verification request to card network 380. The response can be the decision of the financial institution, such as approve, decline, or require additional authentication.

In a number of embodiments, method 400 additionally can include an activity 410 of token service provider 382 generating personalization data, card metadata, and security certifications, which is sent to trusted service manager 384. Trusted service manager 384 personalizes the applet (e.g., 326) or payment token (e.g., 327) for user device 320, and sends the personalized applet (e.g., 326) or payment token (e.g., 327), with the card metadata and security certifications, to device server 330.

In several embodiments, method 400 further can include an activity 412 of device server 330 installing the personalized applet (e.g., 326) or payment token (e.g., 327) on secure component 325 of user device 320.

In a number of embodiments, method 400 additionally can include an activity 414 of device server 330 sending a notification to trusted service manager 384 that tokenization is complete. In many embodiments, the notification can include information about the device, the token, and/or token expiration information.

In several embodiments, method 400 further can include an activity 416 of trusted service manager 384 sending a notification to issuer server 340 that tokenization is complete, which can be similar to the notification sent in activity 414.

In a number of embodiments, method 400 additionally can include an activity 418 of trusted service manager 384 sending a notification to wallet server 350 that tokenization is complete. In many embodiments, the notification can include information about the device, which can be similar to the notification sent in activities 414 and/or 416.

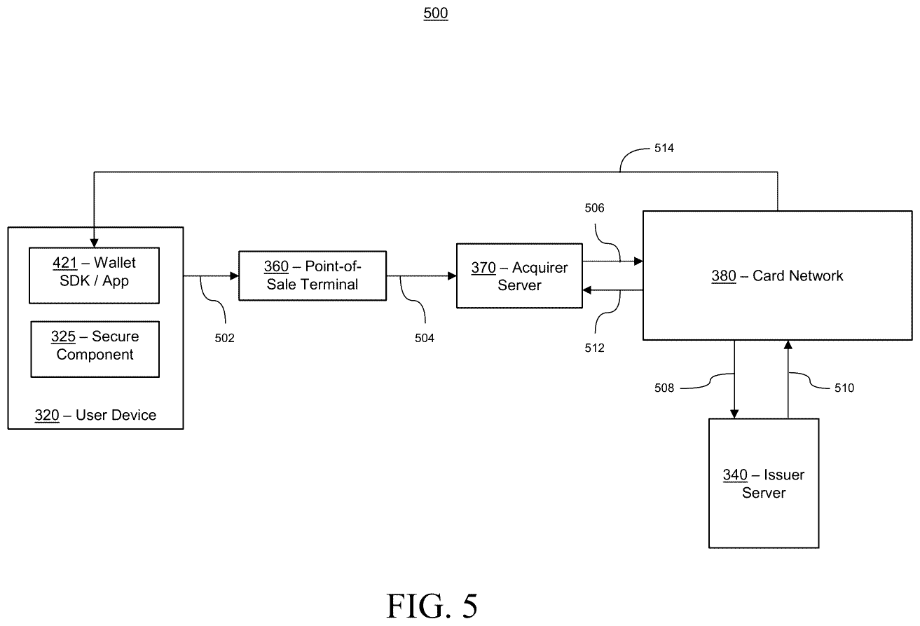

Turning ahead in the drawings, FIG. 5 illustrates a flow diagram of a method 500 of user device 320 performing an in-person (e.g., NFC) transaction using the payment card as it has been provisioned within user device 320, according to an embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, method 500 can be involve various interactions between various components of system 300 (FIG. 3). For example, method 500 can involve interactions between a user device 320, point-of-sale terminal 360, acquirer server 370, card network 380 (including token service provider 382 and trusted service manager 384), and/or issuer server 340. In these or other embodiments, one or more of the activities of method 500 can be implemented as one or more computing instructions configured to run at one or more processors and configured to be stored at one or more non-transitory computer readable media. Such non-transitory computer readable media can be part of system 300 (FIG. 3) and/or the components thereof. The processor(s) can be similar or identical to the processor(s) described above with respect to computer system 100 (FIG. 1). In some embodiments, method 500 and other activities in method 500 can include using a distributed network including distributed memory architecture to perform the associated activity. This distributed architecture can reduce the impact on the network and system resources to reduce congestion in bottlenecks while still allowing data to be accessible from a central location. Although communications between multiple components of system 300 (FIG. 3) are described, it is contemplated that method 500 can be performed by any single component of system 300 (FIG. 3) or by multiple components of system 300 (FIG. 3). For example, method 500 can involve the activities performed by a single component of system 300 (FIG. 3), such as the activities performed by wallet component 421 of user device 320.

Referring to FIG. 5, method 500 can include an activity 502 of the user (e.g., 310 (FIG. 3)) initiating an in-person transaction using user device 320 at point-of-sale terminal 360. In many embodiments, the in-person transaction can be an NFC purchase or another suitable form of checkout to complete the transaction. For example, user device 320 can initiate a “tap to pay” point-of-sale transaction on user device 320 by moving user device 320 within proximity of point-of-sale terminal 360 and completing the purchase portion of the transaction, such as by double clicking the side button of user device 320. If prompted, the user can authenticate with a consumer device cardholder verification method (CDCVM), such as a mobile PIN (personal identification number), passcode, passkey, pattern, biometric identification (e.g., fingerprint, facial recognition, etc.), secure device unlock, or suitable verification method. In a number of embodiments, activity 502 can include user device 320 generating and/or sending a token cryptogram to point-of-sale terminal 360 through NFC communication or another suitable communication.

In several embodiments, method 500 also can include an activity 504 of point-of-sale terminal 360 sending the token cryptogram to acquirer server 370.

In a number of embodiments, method 500 additionally can include an activity 506 of acquirer server 370 submitting an authorization request to card network 380. In many embodiments, the authorization request can be routed to the appropriate card network (e.g., 380) based on the token cryptogram using a token routing table.

In several embodiments, method 500 further can include an activity 508 of card network 380 validating the token cryptogram, performing domain checks and controls, populating domain control fields, and/or sending an authorization request to issuer server 340 for the financial institution that issued the card to decide whether to approve the transaction. For debit transactions routed through an alternate network, card network 380 can provide the alternate network with the debit PAN after validating the token cryptogram and other token data.

In a number of embodiments, method 500 additionally can include an activity 510 of the financial institution authorizing the transaction and issuer server 340 sending an authorization response to card network 380.

In several embodiments, method 500 further can include an activity 512 of card network 380 sending an authorization response to acquirer server 370 and acquirer server 370 providing a receipt (e.g., printing a physical receipt on point-of-sale terminal 360, or emailing a receipt to the user).

In a number of embodiments, method 500 additionally can include an activity 514 of card network 380 sending transaction details to wallet component 421 (e.g., wallet app 321 (FIG. 3), or wallet SDK 323 (FIG. 3) within banking app 322 (FIG. 3), to allow transaction data to be displayed to the user (e.g., 310 (FIG. 3)).

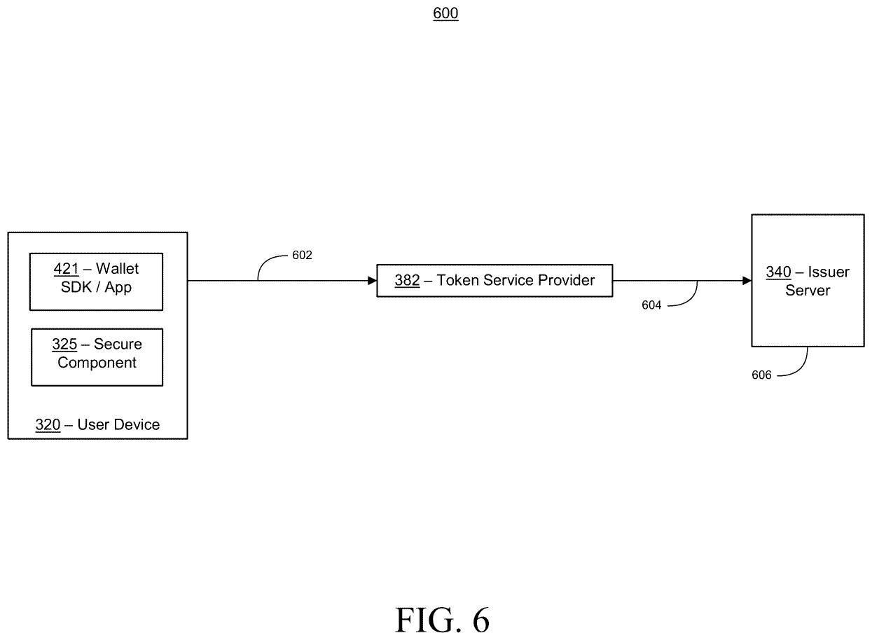

Turning ahead in the drawings, FIG. 6 illustrates a flow diagram of a method 600 of processing a user-initiated lifecycle event, according to an embodiment. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

In many embodiments, method 600 can be involve various interactions between various components of system 300 (FIG. 3). For example, method 600 can involve interactions between a user device 320, token service provider 382, and/or issuer server 340. In these or other embodiments, one or more of the activities of method 600 can be implemented as one or more computing instructions configured to run at one or more processors and configured to be stored at one or more non-transitory computer readable media. Such non-transitory computer readable media can be part of system 300 (FIG. 3) and/or the components thereof. The processor(s) can be similar or identical to the processor(s) described above with respect to computer system 100 (FIG. 1). In some embodiments, method 600 and other activities in method 600 can include using a distributed network including distributed memory architecture to perform the associated activity. This distributed architecture can reduce the impact on the network and system resources to reduce congestion in bottlenecks while still allowing data to be accessible from a central location. Although communications between multiple components of system 300 (FIG. 3) are described, it is contemplated that method 600 can be performed any single component of system 300 (FIG. 3) or by multiple components of system 300 (FIG. 3). For example, method 600 can involve the activities performed by a single component of system 300 (FIG. 3), such as the activities performed by wallet component 421 (e.g., wallet app 321 (FIG. 3), or wallet SDK 323 (FIG. 3) within banking app 322 (FIG. 3)) of user device 320.

Referring to FIG. 6, method 600 can include an activity 602 of the user (e.g., 310 (FIG. 3)) initiating a lifecycle event, such as the user (e.g., 310 (FIG. 3)) placing user device 320 in “lost mode,” which can initiate a suspend request, or the user initiating a deletion of the provisioned payment card from user device 320. Activity 602 can include wallet component 421 sending the suspend/deletion request to token service provider 382.

In several embodiments, method 600 also can include an activity 604 of token service provider 382 suspending or deleting the token, which can include token service provider 382 storing whether the request was initiated by the user or the operating system, and token service provider 382 sending a notification to issuer server 340 of the suspension or deletion request.

In a number of embodiments, method 600 additionally can include an activity 606 of issuer server 340 receiving the notification of the suspension or deletion request and processing the request. In many embodiments, the financial institution that issued the card and operated issuer server 340 cannot override consumer-or operating system-initiated lifecycle events.

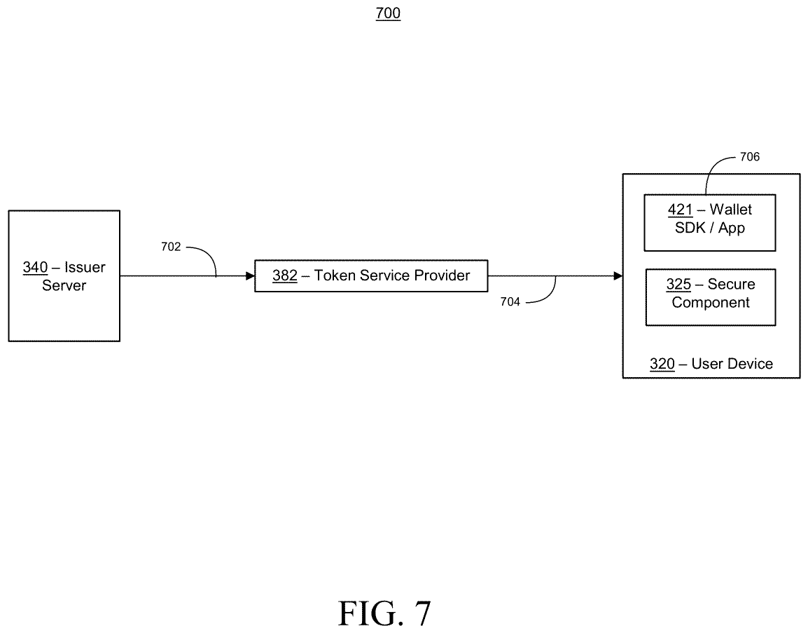

Turning ahead in the drawings, FIG. 7 illustrates a flow diagram of a method 700 of processing an issuer-initiated lifecycle event, according to an embodiment. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped.

In many embodiments, method 700 can be involve various interactions between various components of system 300 (FIG. 3). For example, method 700 can involve interactions between a user device 320, token service provider 382, and/or issuer server 340. In these or other embodiments, one or more of the activities of method 700 can be implemented as one or more computing instructions configured to run at one or more processors and configured to be stored at one or more non-transitory computer readable media. Such non-transitory computer readable media can be part of system 300 (FIG. 3) and/or the components thereof. The processor(s) can be similar or identical to the processor(s) described above with respect to computer system 100 (FIG. 1). In some embodiments, method 700 and other activities in method 700 can include using a distributed network including distributed memory architecture to perform the associated activity. This distributed architecture can reduce the impact on the network and system resources to reduce congestion in bottlenecks while still allowing data to be accessible from a central location. Although communications between multiple components of system 300 (FIG. 3) are described, it is contemplated that method 700 can be performed any single component of system 300 (FIG. 3) or by multiple components of system 300 (FIG. 3). For example, method 700 can involve the activities performed by a single component of system 300 (FIG. 3), such as the activities performed by wallet component 421 (e.g., wallet app 321 (FIG. 3), or wallet SDK 323 (FIG. 3) within banking app 322 (FIG. 3)) of user device 320.

Referring to FIG. 7, method 700 can include an activity 702 of the issuer (e.g., financial institution that issued the payment card) that operates issuer server 340 initiating a suspend or delete request based on a request from the user (e.g., 310 (FIG. 3)) or a determination from the issuer, such as the card having been reported as or determined to be lost or stolen. In many embodiments, activity 702 can include issuer server 340 sending a suspend/delete request to token service provider 382.

In several embodiments, method 700 also can include an activity 704 of token service provider 382 suspending or deleting the token, and token service provider 382 sending a notification to wallet component 421 of the suspension or deletion request.

In a number of embodiments, method 700 additionally can include an activity 706 of wallet component 421 receiving the notification of the suspension or deletion request and processing the request. In many embodiments, wallet component 421 cannot override issuer-initiated lifecycle events. Instead, the issuer can resume/unsuspend a suspended token.

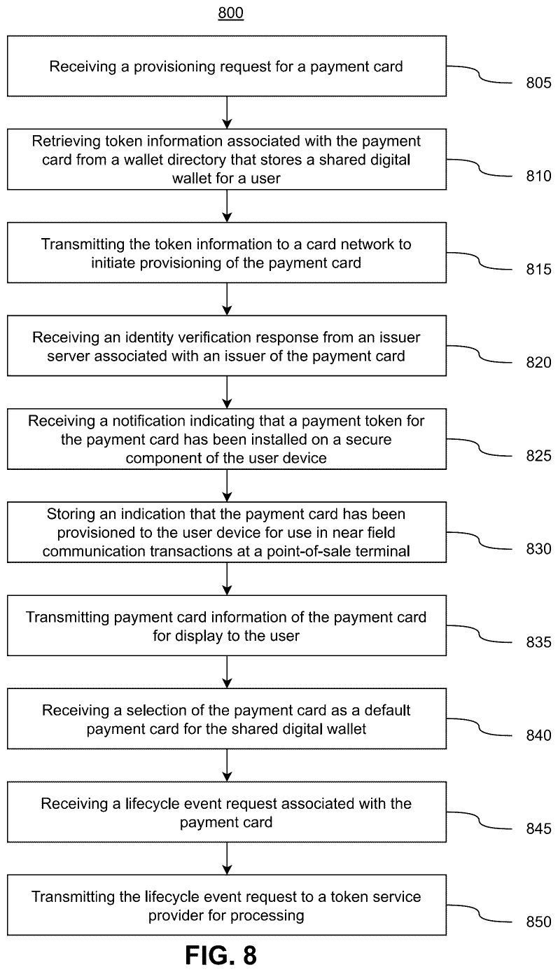

Turning ahead in the drawings, FIG. 8 illustrates a flowchart for a method 800 of performing in-person transactions at point-of-sale terminals using shared digital wallets, according to an embodiment. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped.

In many embodiments, wallet server 350 (FIG. 3) can be suitable to perform method 800 and/or one or more of the activities of method 800. In these or other embodiments, one or more of the activities of method 800 can be implemented as one or more computing instructions configured to run at one or more processors and configured to be stored at one or more non-transitory computer readable media. Such non-transitory computer readable media can be part of wallet server 350 (FIG. 3). The processor(s) can be similar or identical to the processor(s) described above with respect to computer system 100 (FIG. 1). In some embodiments, method 800 and other activities in method 800 can include using a distributed network including distributed memory architecture to perform the associated activity. This distributed architecture can reduce the impact on the network and system resources to reduce congestion in bottlenecks while still allowing data to be accessible from a central location.

Referring to FIG. 8, method 800 can include an activity 805 of receiving, from a user device, a provisioning request for a payment card. The user device can be similar or identical to user device 320 (FIG. 3). The provisioning request can be similar or identical to the provisioning request of activity 404 (FIG. 4). In many embodiments, the provisioning request can include device information about the user device. The device information can include at least one of a type of the secure component of the user device or a type of operating system of the user device. In several embodiments, the provisioning request can include risk information including a device score representing a fraud risk for the user device.

In several embodiments, method 800 also can include an activity 810 of retrieving token information associated with the payment card from a wallet directory that stores a shared digital wallet for a user. In many embodiments, the shared digital wallet can include payment cards from a plurality of different issuers. The wallet directory can be similar or identical to wallet directory 351 (FIG. 3). The token information can be similar or identical to the token information of activity 402 (FIG. 4). In many embodiments, the token information can include a unique identifier for the payment card that is different from a primary account number of the payment card.

In a number of embodiments, method 800 additionally can include an activity 815 of transmitting the token information to a card network to initiate provisioning of the payment card. The card network can be similar or identical to card network 380 (FIG. 3). Activity 815 can be similar or identical to activity 404 (FIG. 4).

In several embodiments, method 800 further can include an activity 820 of receiving an identity verification response from an issuer server associated with an issuer of the payment card. The issuer server can be similar or identical to issuer server 340 (FIG. 3). Activity 820 can be similar or identical to activity 408 (FIG. 4). In many embodiments, the identity verification response can indicate approval, decline, or requesting additional authentication.

In a number of embodiments, method 800 additionally can include an activity 825 of receiving, from the card network, a notification indicating that a payment token for the payment card has been installed on a secure component of the user device. The secure component can be similar or identical to secure component 325 (FIG. 3). The payment token can be similar or identical to payment token 327 (FIG. 3). Activity 825 can be similar or identical to activity 418 (FIG. 4). In many embodiments, the secure component can include a hardware-based secure element within the user device, and the payment token can be stored within an applet installed on the hardware-based secure element. The applet can be similar or identical to applet 326 (FIG. 3). In other embodiments, the secure component can include a host card emulator programmed into a wallet application on the user device. The wallet application can be similar or identical to wallet app 321 (FIG. 3).

In several embodiments, method 800 further can include an activity 830 of storing, in the wallet directory, an indication that the payment card has been provisioned to the user device for use in near field communication transactions at a point-of-sale terminal. The point-of-sale terminal can be similar or identical to point-of-sale terminal 360 (FIG. 3).

In a number of embodiments, method 800 additionally can include an activity 835 of transmitting, to the user device, payment card information of the payment card for display to the user. In many embodiments, the payment card information can include at least one of an account number, a payment card name, or a payment card image.

In several embodiments, method 800 further can include an activity 840 of receiving, from the user device, a selection of the payment card as a default payment card for the shared digital wallet.

In a number of embodiments, method 800 additionally can include an activity 845 of receiving a lifecycle event request associated with the payment card. The lifecycle event request can be similar or identical to the suspend/deletion request of activity 602 (FIG. 6) and/or the suspend/delete request of activity 702 (FIG. 7). In many embodiments, the lifecycle event request can include a suspend request or a delete request. In several embodiments, the lifecycle event request can be initiated by the user placing the user device in a lost mode.

In several embodiments, method 800 further can include an activity 850 of transmitting the lifecycle event request to a token service provider for processing. The token service provider can be similar or identical to token service provider 382 (FIG. 3). Activity 850 can be similar or identical to activity 602 (FIG. 6) and/or activity 702 (FIG. 7).

Although systems and methods for in-person transactions at point-of-sale terminals using shared digital wallets has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the procedures, processes, or activities of FIGS. 4-8 may include different procedures, processes, and/or activities and be performed by many different modules, in many different orders. As another example, the components within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
receiving, from a user device, a provisioning request for a payment card;
retrieving token information associated with the payment card from a wallet directory that stores a shared digital wallet for a user, wherein the shared digital wallet comprises payment cards from a plurality of different issuers;
transmitting the token information to a card network to initiate provisioning of the payment card;
receiving, from the card network, a notification indicating that a payment token for the payment card has been installed on a secure component of the user device; and
storing, in the wallet directory, an indication that the payment card has been provisioned to the user device for use in near field communication transactions at a point-of-sale terminal.

2. The computer-implemented method of claim 1, wherein the token information comprises a unique identifier for the payment card that is different from a primary account number of the payment card.

3. The computer-implemented method of claim 1, wherein:
the provisioning request comprises device information about the user device; and
the device information comprises at least one of:
a type of the secure component of the user device; or
a type of operating system of the user device.

4. The computer-implemented method of claim 1, wherein the provisioning request comprises risk information comprising a device score representing a fraud risk for the user device.

5. The computer-implemented method of claim 1, wherein:
the secure component comprises a hardware-based secure element within the user device; and
the payment token is stored within an applet installed on the hardware-based secure element.

6. The computer-implemented method of claim 1, wherein the secure component comprises a host card emulator programmed into a wallet application on the user device.

7. The computer-implemented method of claim 1, further comprising:
receiving, from the card network, an identity verification response from an issuer server associated with an issuer of the payment card prior to receiving the notification indicating that the payment token has been installed, wherein the identity verification response indicates approval, decline, or requesting additional authentication.

8. The computer-implemented method of claim 1, further comprising:
transmitting, to the user device, payment card information of the payment card for display to the user, wherein the payment card information includes at least one of an account number, a payment card name, or a payment card image.

9. The computer-implemented method of claim 1, further comprising:
receiving, from the user device, a selection of the payment card as a default payment card for the shared digital wallet.

10. The computer-implemented method of claim 1, further comprising:
receiving a lifecycle event request associated with the payment card; and
transmitting the lifecycle event request to a token service provider for processing,
wherein at least one of:
the lifecycle event request comprises a suspend request or a delete request; or
the lifecycle event request is initiated by the user placing the user device in a lost mode.

11. A system comprising one or more processors and one or more non-transitory computer-readable media storing computing instructions that, when executed on the one or more processors, cause the one or more processors to perform operations comprising:
receiving, from a user device, a provisioning request for a payment card;
retrieving token information associated with the payment card from a wallet directory that stores a shared digital wallet for a user, wherein the shared digital wallet comprises payment cards from a plurality of different issuers;
transmitting the token information to a card network to initiate provisioning of the payment card;
receiving, from the card network, a notification indicating that a payment token for the payment card has been installed on a secure component of the user device; and
storing, in the wallet directory, an indication that the payment card has been provisioned to the user device for use in near field communication transactions at a point-of-sale terminal.

12. The system of claim 11, wherein the token information comprises a unique identifier for the payment card that is different from a primary account number of the payment card.

13. The system of claim 11, wherein:
the provisioning request comprises device information about the user device; and
the device information comprises at least one of:
a type of the secure component of the user device; or
a type of operating system of the user device.

14. The system of claim 11, wherein the provisioning request comprises risk information comprising a device score representing a fraud risk for the user device.

15. The system of claim 11, wherein:
the secure component comprises a hardware-based secure element within the user device; and
the payment token is stored within an applet installed on the hardware-based secure element.

16. The system of claim 11, wherein the secure component comprises a host card emulator programmed into a wallet application on the user device.

17. The system of claim 11, wherein the operations further comprise:
receiving, from the card network, an identity verification response from an issuer server associated with an issuer of the payment card prior to receiving the notification indicating that the payment token has been installed, wherein the identity verification response indicates approval, decline, or requesting additional authentication.

18. The system of claim 11, wherein the operations further comprise:
transmitting, to the user device, payment card information of the payment card for display to the user, wherein the payment card information includes at least one of an account number, a payment card name, or a payment card image.

19. The system of claim 11, wherein the operations further comprise:
receiving, from the user device, a selection of the payment card as a default payment card for the shared digital wallet.

20. The system of claim 11, wherein the operations further comprise:
receiving a lifecycle event request associated with the payment card; and
transmitting the lifecycle event request to a token service provider for processing, wherein at least one of:
the lifecycle event request comprises a suspend request or a delete request; or
the lifecycle event request is initiated by the user placing the user device in a lost mode.
